(19) United States
(12) Patent Application Publication
(10) Pub. No.: US 2026/0329745 A1
(43) Pub. Date: Oct. 22, 2026

(54) DATA ARRAY MODIFICATION DEVICE, INFORMATION PROCESSING APPARATUS, DATA ARRAY MODIFICATION METHOD, AND COMPUTER-READABLE STORAGE MEDIUM

(71) Applicant: Fujitsu Limited, Kawasaki-shi (JP)

(72) Inventor: Katsuhiro Yoda, Kodaira (JP)

(73) Assignee: Fujitsu Limited, Kawasaki-shi (JP)

(21) Appl. No.: 19/468,219

(22) Filed: Feb. 3, 2026

(30) Foreign Application Priority Data
Feb. 6, 2025 (JP) 2025-018105

(51) Int. Cl. G06F 12/02; G06F 7/32

(52) U.S. Cl. CPC G06F 12/0207; G06F 7/32; G06F 12/0238; G06F 2212/2542

(57) ABSTRACT

A data array modification device modifies an array of data output from a computational array including a plurality of computational elements arranged in a matrix into an array to be written to a memory. The data array modification device includes compaction circuitry configured to eliminate intervals between predetermined first data included in a data group output from the computational array, and shift the predetermined first data to one end to generate second data, and concatenation circuitry configured to concatenate the second data output from the compaction circuitry to other data and modify the concatenated data into the array to be written to the memory.

### CROSS-REFERENCE TO RELATED APPLICATIONS

This application is based upon and claims the benefit of priority of Japanese Patent Application No. 2025-018105, filed on Feb. 6, 2025, the entire contents of which are incorporated herein by reference.

### FIELD

Certain aspects of the embodiments discussed herein are related to data array modification devices, information processing apparatuses, data array modification methods, and non-transitory computer-readable storage media.

### BACKGROUND

Matrix computations are often extensively used in machine learning such as deep learning, high performance computing (HPC), artificial intelligence (AI), or the like. A known accelerator has a computational array composed of multiple processing elements arranged in a matrix and connected to each other in order to perform a large-scale matrix computation at a high speed (refer to Japanese Laid-Open Patent Publication No. 2024-038122 and U.S. Patent Application Publication No. 2019/0236049, for example).

For example, the computational array of this type of accelerator has a switching circuit arranged around each processing element, and the switching circuit can switch a connection between the processing elements or a connection between a processing element and a data terminal (refer to U.S. Patent Application Publication No. 2019/0317770 and Japanese National Publication of International Patent Application No. 2020-522825, for example).

In a case where multiple switching circuits are provided in the computational array including the multiple processing elements, a control signal for controlling the operation of each processing element and a control signal for controlling the switching of each switching circuit are supplied to the computational array. As a result, a large number of control signal lines are wired in the computational array, to increase a circuit size of the computational array. In addition, as a distance between the processing elements increases and a wiring load between the processing elements increases, a charging and discharging current of the wiring increases to increase a power consumption of the computational array, and a performance of the computational array may deteriorate. Further, in a case where a control of a data array modification device and a control of the computational array are performed by a single controller, a load on the controller increases.

### SUMMARY

One object according to an aspect of the embodiments of the present disclosure is to reduce a load on a controller that controls a computational array while suppressing deterioration in a performance of the computational array, by disposing a data array modification device that modifies an array of data to be supplied to the computational array outside the computational array and autonomously operating the data array modification device.

According to an aspect of the embodiments of the present disclosure, a data array modification device that modifies an array of data output from a computational array including a plurality of computational elements arranged in a matrix into an array to be written to a memory, includes compaction circuitry configured to eliminate intervals between predetermined first data included in a data group output from the computational array, and shift the predetermined first data to one end to generate second data; and concatenation circuitry configured to concatenate the second data output from the compaction circuitry to other data and modify the concatenated data into the array to be written to the memory.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a block diagram illustrating an example of a data array modification device according to an embodiment;

FIG. 2 is a block diagram illustrating an example of an information processing apparatus equipped with the data array modification device of FIG. 1;

FIG. 3 is an explanatory diagram illustrating a problem in a case where the data array modification device of FIG. 1 is not used;

FIG. 4 is an explanatory diagram illustrating an outline of operations of compaction circuitry and concatenation circuitry in FIG. 1;

FIG. 5 is an explanatory diagram illustrating an example of an array modification in a column direction in a case where data compaction is performed by the compaction circuitry in FIG. 1;

FIG. 6 is an explanatory diagram illustrating an example of a configuration of the compaction circuitry in FIG. 1:

FIG. 7 is an explanatory diagram illustrating an outline of an operation of the compaction circuitry in FIG. 6;

FIG. 8 is an explanatory diagram illustrating an example of a selection signal generation algorithm of the compaction circuitry in FIG. 6;

FIG. 9 is a flow chart illustrating an example of a selection signal generation illustrated in the algorithm of the compaction circuitry in FIG. 8;

FIG. 10 is a block diagram illustrating an example of the configuration of the concatenation circuitry in FIG. 1;

FIG. 11 is an explanatory diagram illustrating an outline of an operation of the concatenation circuitry in FIG. 10:

FIG. 12 is an explanatory diagram illustrating an example of an operation algorithm of the concatenation circuitry in FIG. 10;

FIG. 13 is a flow chart illustrating an example of the operation of the concatenation circuitry illustrated in the algorithm of FIG. 12;

FIG. 14 is a flow chart illustrating a continuation the operation of FIG. 13;

FIG. 15 is an explanatory diagram illustrating an outline of an operation of an output generator in FIG. 10;

FIG. 16 is a block diagram illustrating an example of the data array modification device according to another embodiment;

FIG. 17 is an explanatory diagram illustrating an example of performing a matrix multiplication by operating the computational array of FIG. 16 as a systolic array;

FIG. 18 is an explanatory diagram illustrating an example in which an input of a matrix C to the computational array illustrated in FIG. 17 (a) is implemented by a delay slot;

FIG. 19 is an explanatory diagram illustrating an example in which an output of the matrix C from the computational array illustrated in FIG. 17 (c) is implemented by the data array modification device;

FIG. 20 is a block diagram illustrating an example of the data array modification device according to another embodiment;

FIG. 21 is an explanatory diagram illustrating an outline of the operation of the data array modification device of FIG. 20; and

FIG. 22 is an explanatory diagram illustrating an example of a configuration of an aggregator in FIG. 20.

### DESCRIPTION OF EMBODIMENTS

Hereinafter, embodiments will be described with reference to the drawings. In the following description, a signal line through which a signal is transmitted is designated by the same reference numeral as the name of the signal, and a data line through which data is transmitted is designated by the same reference numeral as the name of the data.

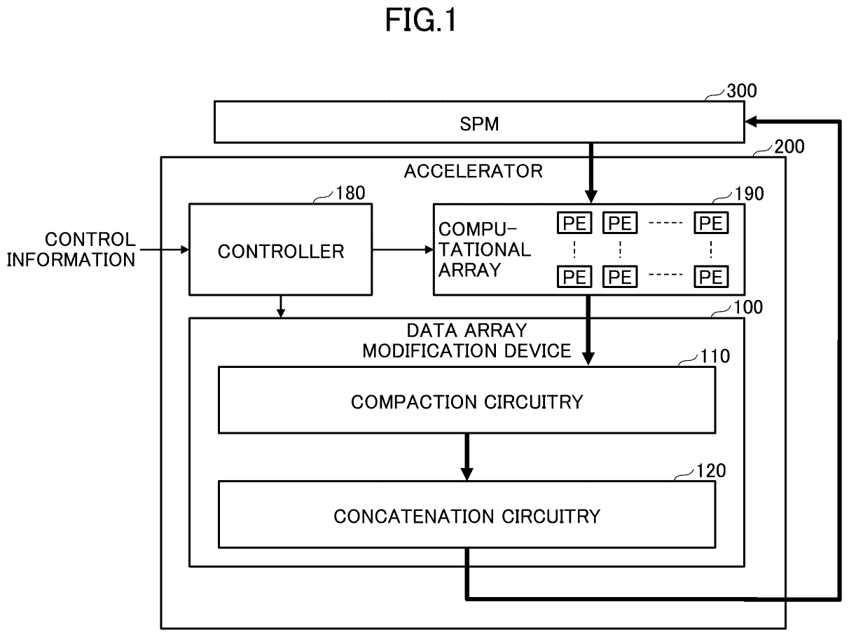

FIG. 1 illustrates an example of a data array modification device according to an embodiment. For example, a data array modification device 100 illustrated in FIG. 1 is provided in an accelerator 200, together with a controller 180 and a computational array 190 that includes plurality of processing elements (PEs). The data array modification device 100 includes compaction circuitry 110 and concatenation circuitry 120. The data array modification device 100 and the computational array 190 are connected to a scratchpad memory (SPM) 300. The PE is an example of a computational element.

For example, the accelerator 200 repeats an operation of performing a matrix computation or the like of data read from the SPM 300 by the computational array 190 and an operation of storing the computation result in the SPM 300 via the data array modification device 100. Accordingly, the accelerator 200 can perform machine learning, such as deep learning or the like, or scientific and technical computation. The controller 180 interprets control information received from an external controller, such as a central processing unit (CPU) or the like, controls an inside of the computational array 190, and controls the data array modification device 100. Examples of the control information with respect to the computational array 190 include a load instruction, a store instruction, and an instruction to perform a matrix multiplication or the like in the computational array 190, for example.

In the data array modification device 100, the compaction circuitry 110 compresses the array of data indicating the computation results output from the computational array 190 at intervals in a column direction by left-aligning, for example, and outputs the compressed data to the concatenation circuitry 120. The concatenation circuitry 120 concatenates the data sequentially received from the compaction circuitry 110, and writes the concatenated data into the SPM 300 every time the concatenated data reaches a write size of the SPM 300. In FIG. 1, the data array modification device 100 is disposed inside the accelerator 200, but the data array modification device 100 may be disposed outside the accelerator 200.

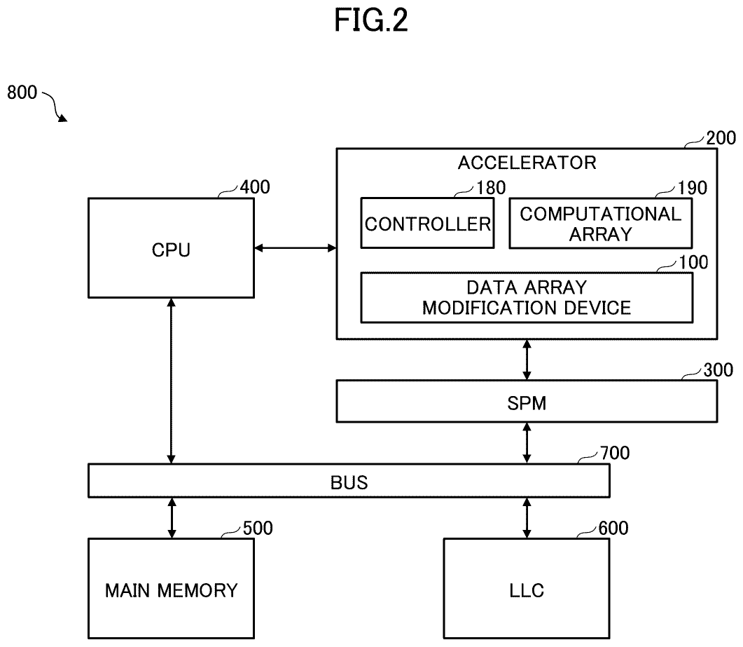

FIG. 2 illustrates an example of an information processing apparatus equipped with the data array modification device 100 of FIG. 1. An information processing apparatus 800 illustrated in FIG. 2 includes the accelerator 200, the SPM 300, a CPU 400, a main memory 500, such as a high bandwidth memory (HBM) or the like, and a last level cache (LLC) 600. The information processing apparatus 800 also includes a bus 700 that connects the SPM 300, the CPU 400, the main memory 500, and the LLC 600 to one another. A configuration of the information processing apparatus 800 equipped with the data array modification device 100 is not limited to the example illustrated in FIG. 2.

The CPU 400 controls an operation of the computational array 190. Further, the CPU 400 transfers parameters used for an operation of the data array modification device 100, such as compaction information CompactionSize, an offset information Offset, or the like to the data array modification device 100.

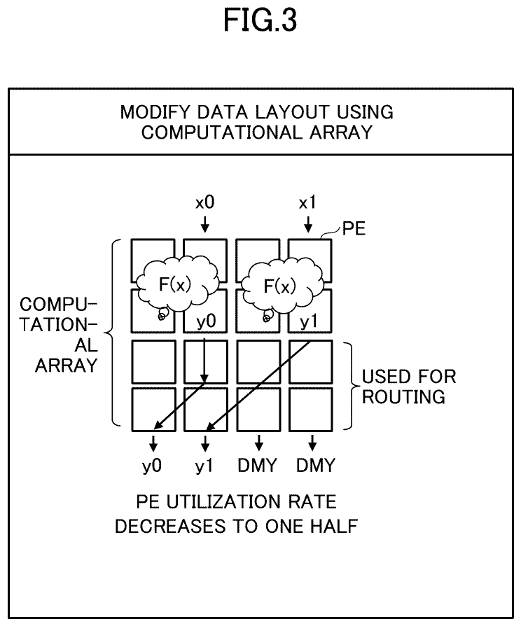

FIG. 3 illustrates a problem in a case where the data array modification device 100 of FIG. 1 is not used. Data y0 and y1, which are computation results of the computational array on data x0 and x1, are output from the computational array at intervals in the column direction, for example. In a case where the interval of the data y0 and y1 is shortened and the data y0 and y1 are shifted to the left, for example, some PEs of the computational array are used for routing the data y0 and y1. Further, the computational array outputs the data y0 and y1 with the shortened interval by the routing of the PEs and dummy data DMY inserted in a vacant column. In the example illustrated in FIG. 3, a utilization rate of the PE that executes a computation F(x), that is, a PE utilization rate, is halved, and a computational efficiency (or a processing efficiency) decreases.

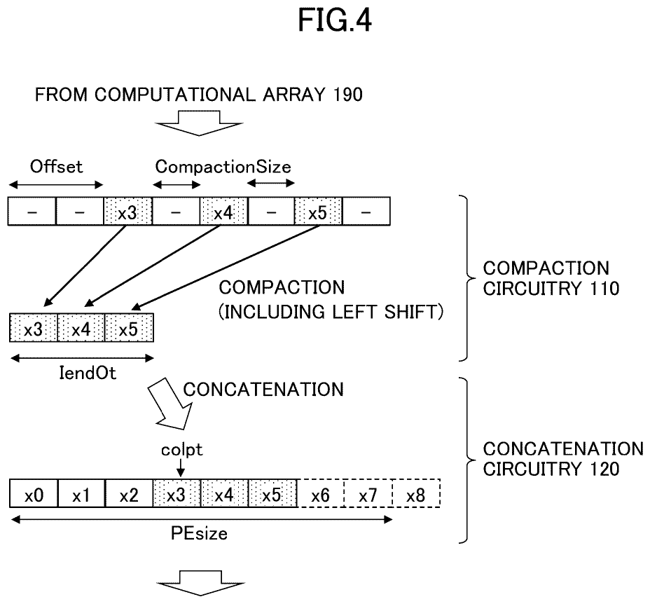

FIG. 4 illustrates an outline of operations of the compaction circuitry 110 and the concatenation circuitry 120 in FIG. 1. The compaction circuitry 110 eliminates intervals of data x3, x4, and x5 included in the data group output from the computational array 190 at the intervals indicated by compaction information CompactionSize in the column direction and shifts the data to one end (left end), and outputs the shifted data to the concatenation circuitry 120. In this case, the compaction circuitry 110 shifts the data x3 of the first column to the left by a number of columns indicated by the offset information Offset.

A modification of an array of the data x3, x4, and x5 by the compaction circuitry 110 includes a process of shortening the intervals and a process of shifting to the left. The data x3, x4, and x5 output from the computational array 190 are examples of first data, and the data x3, x4, and x5 output from the compaction circuitry 110 to the concatenation circuitry 120 are examples of second data. Hereinafter, a plurality of data indicating the computation results output from the computational array 190 are also referred to as a data group. The number of data included in the data group may be two or more.

The concatenation circuitry 120 concatenates the data x3, x4, and x5 with the shortened intervals received from the compaction circuitry 110 after the data x0, x1, and x2 that are already held. That is, the data groups sequentially received from the computational array 190 are concatenated by the concatenation circuitry 120. A code colpt is a column pointer indicating a column from which storage of data newly received by the concatenation circuitry 120 is to start. In a case where the concatenation circuitry 120 holds data (for example, data x0 through x7 amounting to one row) having a column size PESize, which is the size of one write to the SPM 300, the held data amounting to one row is written into the SPM 300. In the example illustrated in FIG. 4, the column size PESize is “8” indicating eight data.

The concatenation circuitry 120 receives the next data group of data x6, x7, and x8 indicated by the broken line boxes in FIG. 4 from the compaction circuitry 110, and initializes the column pointer colpt to “0” in a case where the data being held exceed the column size PESize. Further, the concatenation circuitry 120 holds the data x8 in an area indicated by the initialized column pointer colpt, and updates the column pointer colpt.

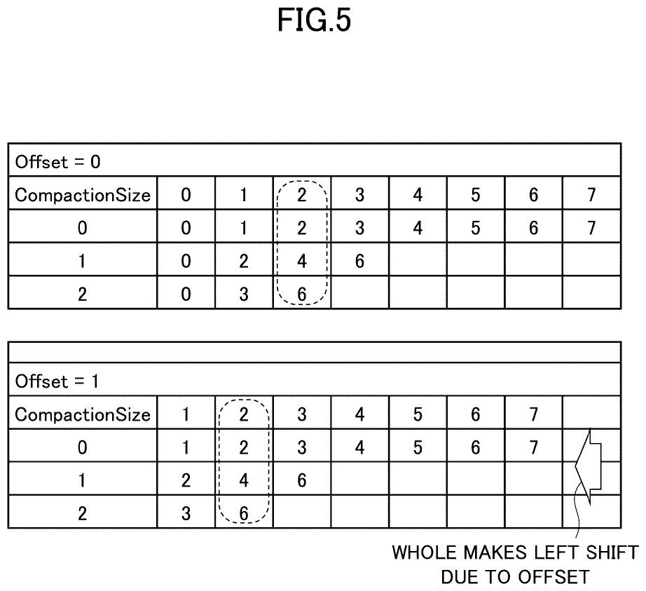

FIG. 5 illustrates an example of an array modification in the column direction in a case where data compaction is performed by the compaction circuitry 110 in FIG. 1. Each data received from the computational array 190 is shifted to the left to a position indicated by a multiple of the column number by the compaction (left shift) of the array in the column direction. In a case where the offset information Offset is greater than or equal to “1”, the position to be shifted to the left is shifted to the left by the offset information Offset for the entire column.

For example, when Offset=“0”, the second data from the left, which is indicated by the column number=“2” indicated by the broken line box and output from the compaction circuitry 110, is one of the data indicated by the column numbers=“2”, “4”, and “6” input to the compaction circuitry 110. The compaction information CompactionSize determines the column from which each data is output. A shift amount of each column is less than or equal to the value of the column number.

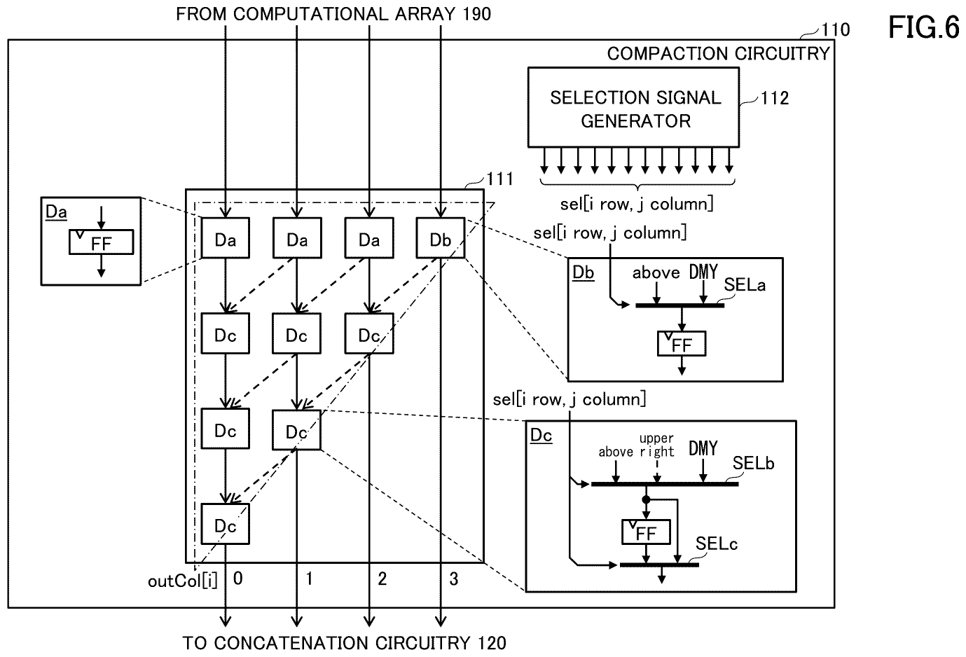

FIG. 6 illustrates an example of a configuration of the compaction circuitry 110 illustrated in FIG. 1. The compaction circuitry 110 includes an m row by m column data holding array 111, and a selection signal generator 112, where m is an integer greater than or equal to two. The data holding array 111 includes data holding elements D (Da, Db, and Dc) included in a triangular region indicated by a one-dot chain line with an upper side as a base of the triangular region and a lower left as a vertex of the triangular region. Each row of the data holding array 111 includes {m−(row number)+1} data holding elements D. The data holding elements D in the second and subsequent rows are aligned to the left end at the first column of the data holding array 111. The data holding element Da is an example of a first data holding element, the data holding element Db is an example of a second data holding element, and the data holding element Dc is an example of a third data holding element.

In the example illustrated in FIG. 6, the data holding array 111 is formed by four rows by four columns according to a column size of the data received from the computational array 190 in a single input and a column size of the data output to the SPM 300 in a single output. In the data holding array 111, a dashed arrow indicates a path of the data received from an upper right data holding element D located diagonally upward to the right.

The data holding element Da includes a flip-flop circuit FF that holds the data received from the computational array 190 and outputs the held data. The flip-flop circuit FF is an example of a holding circuit. The data holding element Db includes a selector SELa that selects the data received from the computational array 190 or the dummy data DMY according to a selection signal sel[i row, i column], and a flip-flop circuit FF that holds the data selected by the selector SELa and outputs the held data. The selector SELa is an example of a first selector.

The data holding element Dc includes a selector SELb that selects one of the data output from the upper data holding element D, the data output from the upper right data holding element D, or the dummy data DMY according to the selection signal sel[i row, i column]. The selector SELb is an example of a second selector.

In addition, the data holding element Dc includes a flip-flop circuit FF that holds the data output from the selector SELb. The data holding element Dc further includes a selector SELc that selects and outputs the data output from the selector SELb or the data output from the flip-flop circuit FF according to the selection signal sel[i row, i column]. The selector SELc is an example of a third selector. The selector SELc can output the data selected by the selector SELb by passing through the data without holding the data in the flip-flop circuit FF.

The selection signal generator 112 has a function of generating the selection signal sel[i row, i column] for each data holding element D according to the compaction information CompactionSize and the offset information Offset. A logical value of the selection signal sel[i row, i column] generated by the selection signal generator 112 is set when the compaction information CompactionSize and the offset information Offset are determined. In addition, the logical value of the selection signal sel[i row, i column] is maintained until the compaction information CompactionSize and the offset information Offset are varied.

The data holding array 111 left-aligns each data of the data group received from the computational array 190 and outputs the left-aligned data to the concatenation circuitry 120. Accordingly, the compaction circuitry 110 can autonomously modify the column to which each data of the data group received from the computational array 190 is output, according to the offset information Offset and the compaction information CompactionSize, without being controlled by an external controller or the like. The compaction circuitry 110 can output each data of the data group from one of output terminals outCol[0] through outCol[3].

In addition, in the data holding array 111, only the data holding elements D required to modify the data array are provided, instead of providing m ×m data holding elements D of m rows by m columns, to enable reduction of the circuit scale of the data holding array 111. Hence, it is possible to reduce the circuit scale of the compaction circuitry 110. Moreover, by providing the selector SELc in the data holding element Db, the data received from the upper row can be passed through, and as will be described later, delay amounts of the data included in the data group can be made uniform.

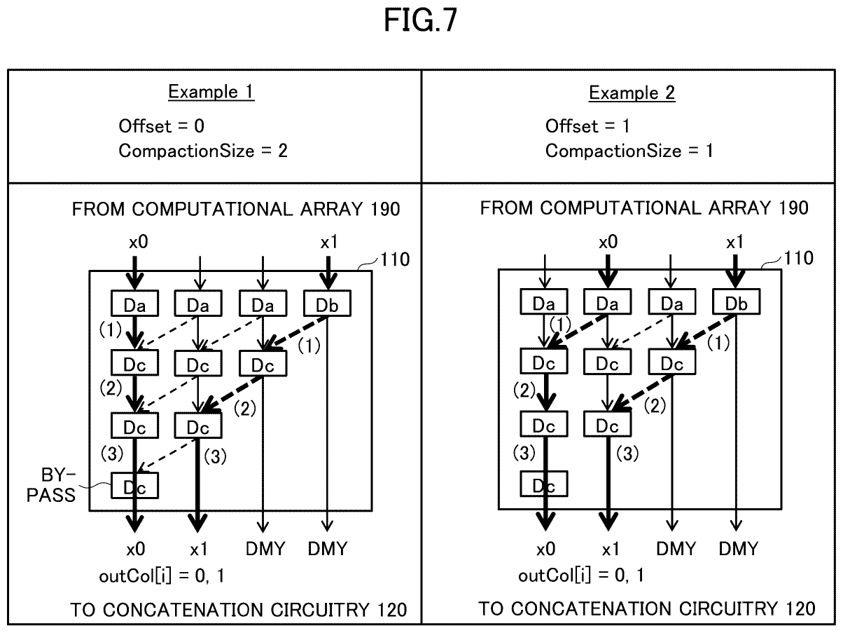

FIG. 7 illustrates an outline of the operation of the compaction circuitry 110 in FIG. 6. In FIG. 7, a number of data (hereinafter also referred to as “data number”) IendOt, included in the data group to be output from the computational array 190 in a single output, is “2”. In an example 1, the data x0 and x1 received from the computational array 190 with Offset=“0” and CompactionSize=“2” are left-aligned and output to the concatenation circuitry 120. In the example 1, the data x0 is sequentially transferred to the data holding elements Da and Dc immediately below, and is passed through the last data holding element Dc. The data x1 is transferred twice to the lower left data holding element Dc located diagonally downward to the left, and after reaching the column to which the data x1 is to be output, the data x1 is transferred to the data holding element Dc immediately below. As a result, the data x0 and x1 are output to the output terminals outCol[i]=0, 1.

In an example 2, the data x0 and x1 received from the computational array 190 with Offset=“1” and CompactionSize=“1” are left-aligned and output to the concatenation circuitry 120. In the example 2, the data x0 is transferred once to the lower left data holding element Dc located diagonally downward to the left, reaches the column to which the data x0 is to be output, and is transferred twice to the data holding element Dc immediately below. In the example 2, the data x0 is also passed through the last data holding element Dc. Similar to the example 1, the data x1 is transferred twice to the lower right data holding element Dc located diagonally downward to the right, and after reaching the column to which the data x1 is to be output, the data x1 is transferred to the data holding element Dc located immediately below. As a result, the data x0 and x1 are output to the output terminals outCol[i]=0, 1.

In the examples 1 and 2, in the lowermost data holding element Dc to which the data x0 is transferred, the data x0 is passed through, so that the delay amounts of the data x0 and x1 in the compaction circuitry 110 can be made uniform. Thus, the concatenation circuitry 120 can concatenate the data x0 and x1 with other data without performing a delay amount adjustment or a delay amount processing.

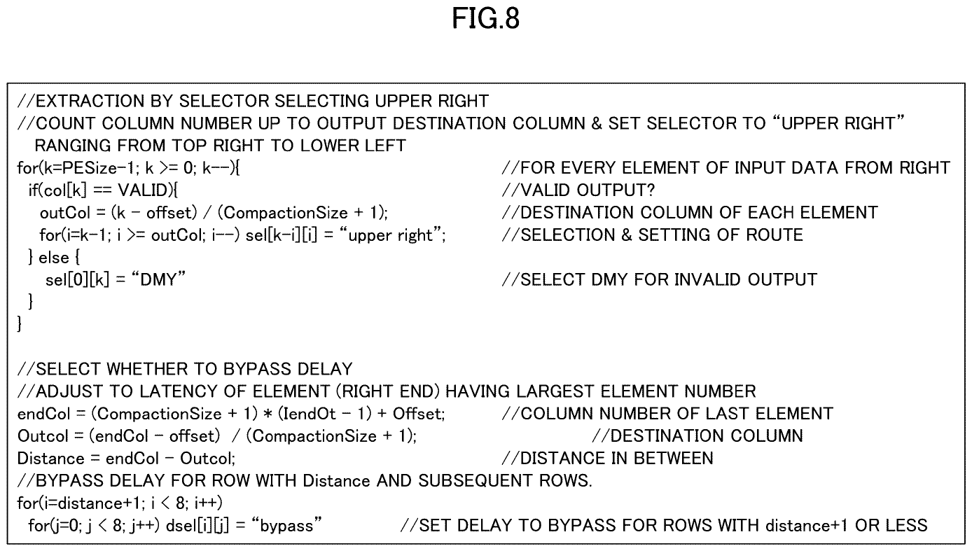

FIG. 8 illustrates an example of an algorithm for generating the selection signal sel of the compaction circuitry 110 in FIG. 6. The selection signal generation algorithm illustrated in FIG. 8 determines the logic of the selection signal sel supplied to each of the selectors SELa, SELb, and SELc of each data holding element D of the compaction circuitry 110. The logic of the selection signal sel is determined using parameters, such as the column size PESize, the offset information Offset, the compaction information CompactionSize, or the like. FIG. 8 illustrates an example of a data array modification program.

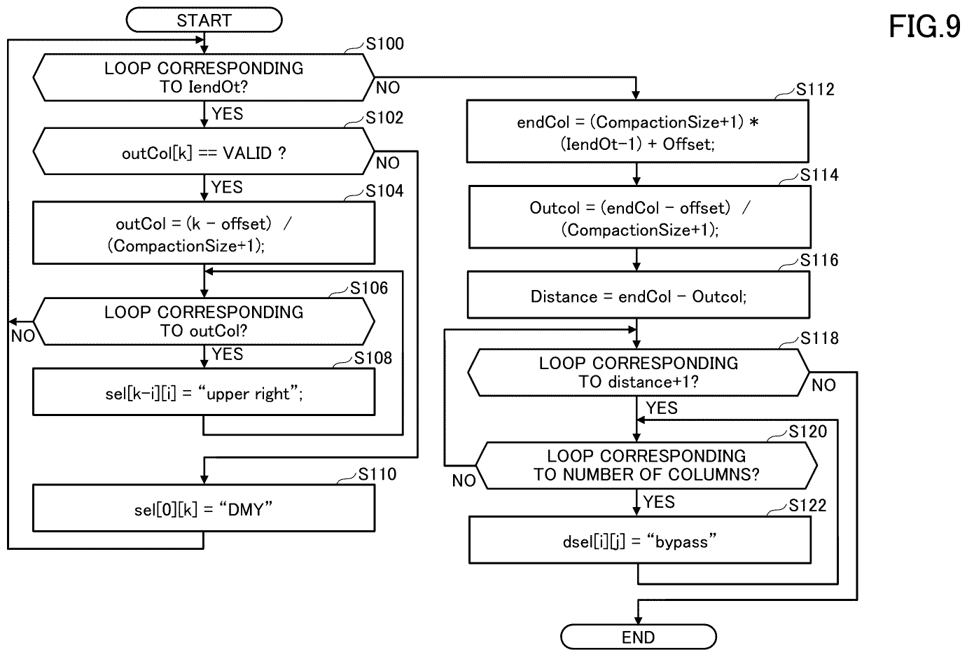

The selection signal generation algorithm illustrated in FIG. 8 may be executed at a frequency similar to a frequency of modifying mapping of the PEs included in the computational array 190, or may be executed by software in advance before the computation is performed by the computational array 190. After the logic of the selection signal sel is determined set, the compaction circuitry 110 switches the selectors SELa, SELb, and SELc according to the logic of the selection signal sel, and compresses the data received from the computational array 190 according to the setting. FIG. 8 illustrates the selection signal generation algorithm for generating the selection signal sel in the case where the computational array 190 has eight rows by eight columns. Processes according to the selection signal generation algorithm of FIG. 8 can be performed by a procedure illustrated in FIG. 9.

FIG. 9 is a flow chart illustrating an example of the processes according to the selection signal generation algorithm of the compaction circuitry 110 in FIG. 8 for generating the selection signal sel. FIG. 9 illustrates an example of a data array modification method. The processes of the flow chart illustrated in FIG. 9 may be implemented by hardware installed in the data array modification device 100, or may be implemented by a data array modification program executed by a computer, such as a CPU or the like, installed in the data array modification device 100. In the examples illustrated in FIG. 8 and FIG. 9, the computational array 190 includes right rows and eight columns of PEs, and the number of data outputs is eight at maximum (that is, eight columns). The data array modification program may be stored in any suitable non-transitory computer-readable storage medium, such as a semiconductor memory device, a magnetic recording medium, a magneto-optical recording medium, an optical recording medium, or the like, for example.

First, in step S100, the compaction circuitry 110 determines whether or not to continue a loop process corresponding to the data number IendOt. In a case where the loop process corresponding to the data number of IendOt is not completed, the compaction circuitry 110 performs the process of step S102 to continue the loop process, and the compaction circuitry 110 performs the process of step S112 in a case where the loop process corresponding to the data number IendOt is completed. In step S102, the compaction circuitry 110 determines whether or not a column col[k] to which the data is to be output for every data amounting to the data number IendOt is valid. The compaction circuitry 110 performs the process of step S104 in a case where the column col[k] is valid (in a case where the data is output), and performs the process of step S110 in a case where the column col[k] is invalid (in a case where the data is not output). In the examples 1 and 2 illustrated in FIG. 7, the outputs terminals outCol[0] and outCol[1] are determined to be valid, and the output terminals outCol[2] and outCol[3] are determined to be invalid.

In step S104, the compaction circuitry 110 computes the number assigned to the output terminals outCol to which each data is to be output, using the offset information Offset and the compaction information CompactionSize. Next, in step S106, the compaction circuitry 110 determines whether or not to continue the loop process corresponding to the output terminals outCol. In a case where the loop process corresponding to the output terminals outCol is not completed, the compaction circuitry 110 performs the process of step S108 to continue the loop process. On the other hand, in a case where the loop process corresponding to the output terminals outCol is completed, the compaction circuitry 110 returns to the process of step S100.

In step S108, the compaction circuitry 110 sets a selection signal sel[k-1][i] so as to select the data from the upper right data holding element D. For every data output to each output terminal outCol, the compaction circuitry 110 generates a selection signal sel[k-1][i] for selecting the data holding element D located immediately above, with respect to the data holding element D that does not select the upper right data holding element D. Accordingly, the compaction circuitry 110 can autonomously set the selection signal sel.

In the path of the data x1 in the example 1 in FIG. 7, the data holding elements D in the second and third rows from the top select the upper right data holding element D. In the path of the data x0 in the example 2 in FIG. 7, the data holding element D in the second and third rows from the top select the upper right data holding element D. In the path of the data x1 in the example 2 in FIG. 7, the data holding elements D in the second and third rows from the top select the upper right data holding element D.

In a case where it is determined in step S102 that the data is not to be output, the compaction circuitry 110 generates a selection signal sel[0][k] for selecting the dummy data DMY in step S110, and returns to the process of step S100.

On the other hand, in step S112, the compaction circuitry 110 computes an input column number endCol of the column to which the last data of the data group is to be input from the computational array 190, using the compaction information CompactionSize, the offset information Offset, and the data number IendOt. The input column number endCol becomes “3” in both the examples 1 and 2 in FIG. 7.

Next, in step S114, the compaction circuitry 110 computes a destination column number Outcol of the column that is to output the last data of the data group input from the computational array 190 to the concatenation circuitry 120. The destination column number Outcol is computed using the input column number endCol, the offset information Offset, and the compaction information CompactionSize. The destination column number Outcol becomes “1” in both the examples 1 and 2 in FIG. 7.

Next, in step S116, the compaction circuitry 110 computes a difference between the input column number endCol and the destination column number Outcol as a distance Distance (the number of columns). The distance Distance becomes “2” in both the examples 1 and 2 in FIG. 7.

In step S118, the compaction circuitry 110 determines whether or not to continue the loop process corresponding to the distance Distance+1. The loop process corresponding to the distance Distance+1 is a loop process from the distance Distance+1 to the last column number (“3” which is less than “4” in FIG. 7, and “7” which is less than “8” in the algorithm of FIG. 8). In a case where the process corresponding to the length Distance+1 is not completed, the compaction circuitry 110 performs the process of step S120 to continue the loop process. On the other hand, in a case where the process corresponding to the distance Distance+1 is completed, the compaction circuitry 110 ends the procedure illustrated in FIG. 9.

In step S120, the compaction circuitry 110 determines whether or not to continue the loop process corresponding to the number of columns to set the data holding element D having a distance Distance−1 or less to a through state. In the case where the loop process corresponding to the number of columns is completed, the compaction circuitry 110 performs the process of step S122 to continue the loop process. In the case where the loop process corresponding to the number of columns is completed, the compaction circuitry 110 returns to the process of step S118 and performs the loop process for a next distance Distance+1. In step S122, the compaction circuitry 110 sets the selector SLEb of the data holding element D indicated by dsel[i][j] to the through state, and returns to the process of step S120. In the examples 1 and 2 in FIG. 7, the selector SLEb of the data holding element D in the fourth row (i=3) and the first column (j=0) indicated by dsel[i][j] is set to the through state.

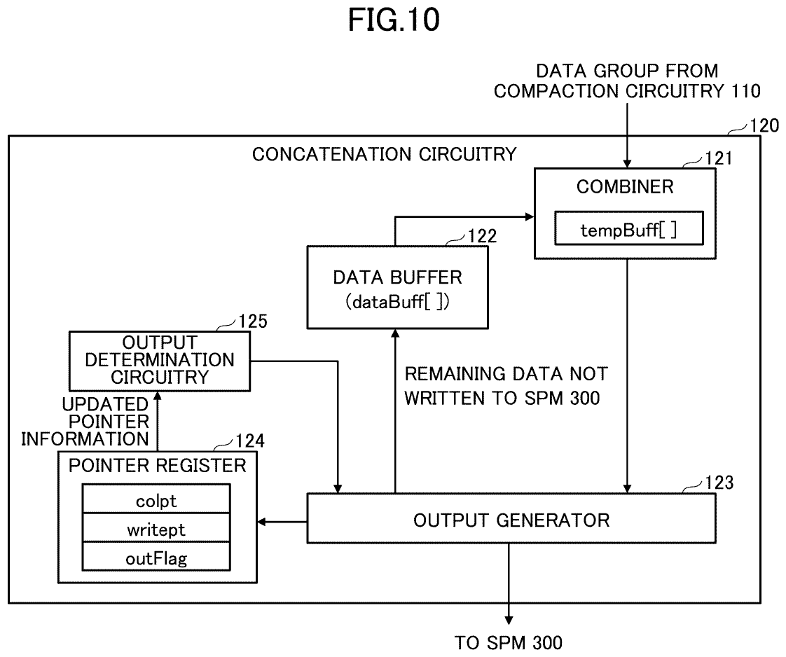

FIG. 10 illustrates an example of a configuration of the concatenation circuitry 120 in FIG. 1. The concatenation circuitry 120 includes a combiner 121, a data buffer 122, an output generator 123, a pointer register 124, and output determination circuitry 125. The combiner 121 includes a register tempBuff[ ] that combines the data group supplied from the compaction circuitry 110 with the data held in the data buffer 122. The data buffer 122 holds the data that is not output to the SPM 300 by the output generator 123 among the data combined by the combiner 121. In the following, the data buffer 122 may also be referred to as “dataBuff[ ]”, and the register tempBuff[ ] may also be referred to as “tempBuff[ ]”.

The output generator 123 generates, as one row of data to be written into the SPM 300, data having a column size PESize (for example, one row of data x0 through x7), which is the size of one write to the SPM 300, among the data that are combined using the register tempBuff[ ]. The output generator 123 can read the data held in the register tempBuff[ ].

The output generator 123 writes the generated data corresponding to one row into the SPM 300, and returns the remaining data not written into the SPM 300 to the output data buffer 122. In addition, the output generator 123 updates the column pointer colpt (not illustrated) of the data buffer 122, based on the data retrieved from the register tempBuff[ ] of the concatenation circuitry 120 and written into the SPM 300.

The pointer register 124 holds the values of the column pointer colpt, a write row pointer writept indicating a write position in the SPM 300, and an output flag outFlag indicating an instruction to output data to the SPM 300. When the value of the column pointer colpt exceeds the column size PESize (not illustrated), the output determination circuitry 125 outputs to the output generator 123 an instruction to write one row of data into the SPM 300.

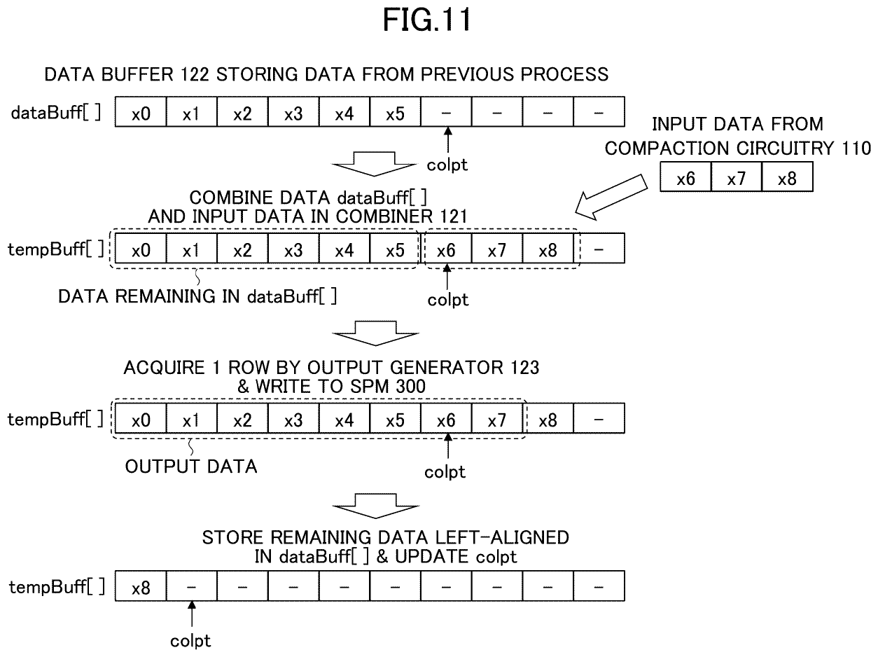

FIG. 11 illustrates an outline of the operation of the concatenation circuitry 120 in FIG. 10. In the example illustrated in FIG. 11, the combiner 121 receives the next input data x6 through x8 from the compaction circuitry 110 in a state where the data x0 through x5 are held in the dataBuff[ ]. The column pointer colpt indicates an area next to the area where the data x5 is held.

The combiner 121 combines the data x0 through x5 remaining in the dataBuff[ ] and the input data x6 through x8 using the tempBuff[ ]. When the output flag outFlag indicates the write, the output generator 123 retrieves, from the combined data x0 through x8, the data x0 through x7 having the column size PESize as output data from the tempBuff[ ]. The output generator 123 writes the data x0 through x7 retrieved from the tempBuff[ ] to the position indicated by the write row pointer writept in the SPM 300.

The output generator 123 stores the remaining data x8 in the tempBuff[ ], not to be written into the SPM 300, left-aligned in the dataBuff[ ], and updates the column pointer colpt. Then, the concatenation circuitry 120 repeats an operation similar to that of FIG. 11, every time the concatenation circuitry 120 receives the next input data from the compaction circuitry 110.

As illustrated in FIG. 11, the concatenation circuitry 120 concatenates the data held in data buffer dataBuff[ ] and the data input from the compaction circuitry 110 in the register tempBuff[ ]. When the size of the concatenated data exceeds the column size PESize, the concatenation circuitry 120 writes the data corresponding to the column size PESize into the SPM 300. Thus, the concatenation circuitry 120 can autonomously perform an operation of concatenating the left-aligned data of the data group sequentially received from the compaction circuitry 110 and writing the data having the write size into the SPM 300 every time the concatenated data reaches the write size (PESize) of the SPM 300.

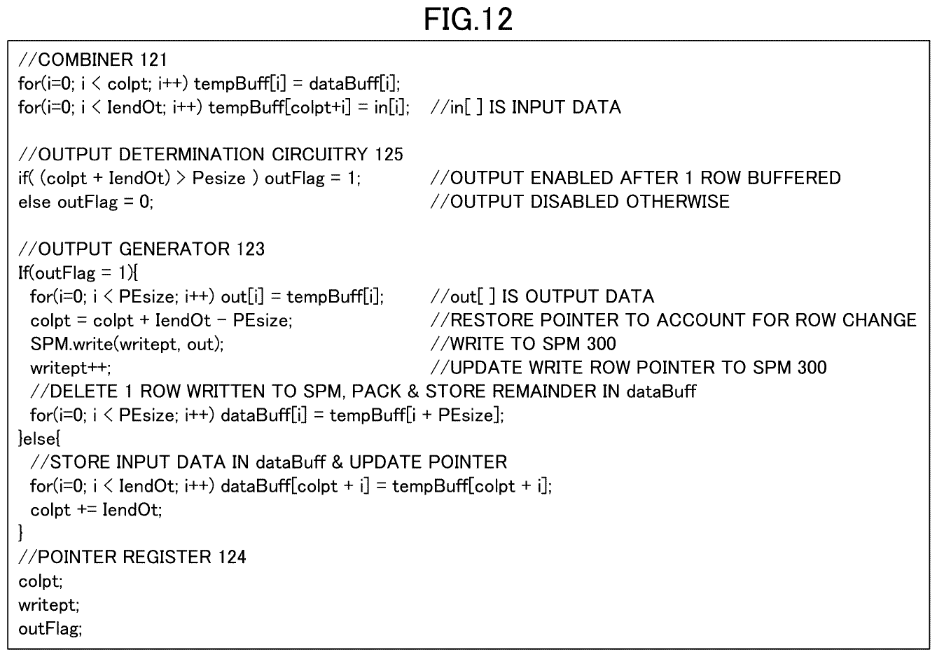

FIG. 12 illustrates an example of an operation algorithm of the concatenation circuitry 120 in FIG. 10. FIG. 12 illustrates operations of the combiner 121, the output determination circuitry 125, and the output generator 123. The pointer register 124 holds the column pointer colpt, a write row pointer writept, and the output flag outFlag.

The combiner 121 transfers the data held in data buffer dataBuff[ ] to the register tempBuff[ ] while updating the column pointer colpt. Further, the combiner 121 combines the input data corresponding to the data number IendOt from the compaction circuitry 110 with the data held in the register tempBuff[ ] in the register tempBuff[ ] while updating the column pointer colpt.

When a sum of the column pointer colpt and the data number IendOt exceeds the column size PESize, the output determination circuitry 125 sets the output flag outFlag to be output to the output generator 123 to “1” to write the data corresponding to the column size PESize into the SPM 300. In a case where the sum of the column pointer colpt and the data number IendOt is the column size PESize or less, the output determination circuitry 125 sets the output flag outFlag to “0” to prevent the output generator 123 from writing the data into the SPM 300.

In a case where the output flag outFlag is “1”, the output generator 123 retrieves the data corresponding to the column size PESize held in the register tempBuff[ ], writes the retrieved data into the SPM 300, and updates the write pointer writept according to the data number of written data. The output generator 123 stores the remaining data, excluding the data written into the SPM 300, among the data held in the register tempBuff[ ], into the data buffer dataBuff[ ], and updates the column pointer colpt. As a result, the data corresponding to the column size PESize written into the SPM 300 is deleted from the data buffer dataBuff[ ].

In a case where the output flag outFlag is “0”, the output generator 123 transfers the data corresponding to the data number IendOt, input from the compaction circuitry 110 and held in the register tempBuff[ ], to the data buffer dataBuff[ ].

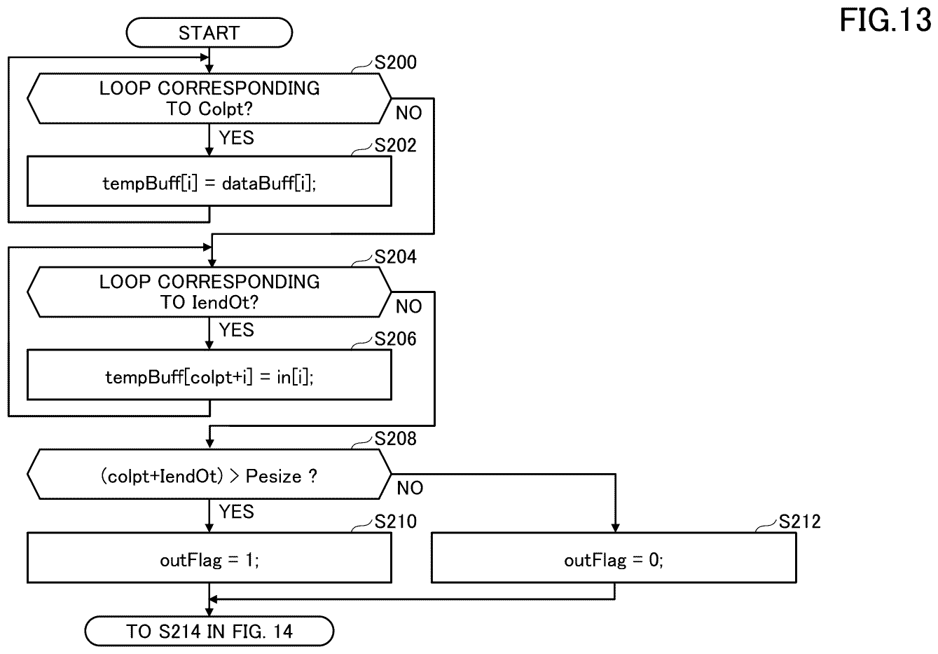

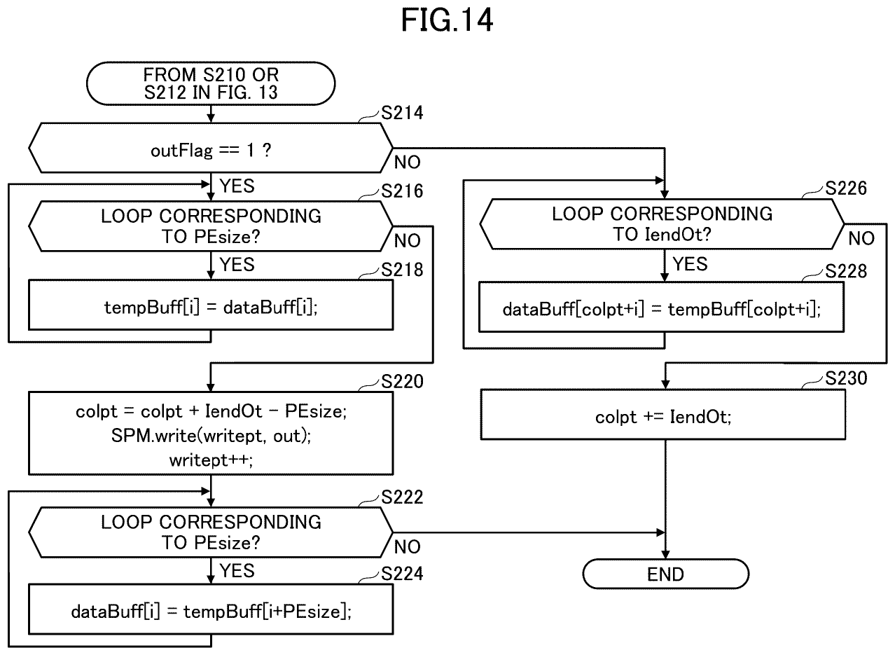

FIG. 13 and FIG. 14 illustrate an example of the operation of the concatenation circuitry 120 illustrated in the algorithm of FIG. 12. In step S200, the concatenation circuitry 120 determines whether or not to continue the loop process corresponding to the current column pointer colpt. The concatenation circuitry 120 performs the process of step S202 in a case where the loop process corresponding to the column pointer colpt is not completed, and performs the process of step S204 in a case where the loop process corresponding to the column pointer colpt is completed. In step S202, the concatenation circuitry 120 transfers the data held in the data buffer dataBuff[ ] to the register tempBuff[ ] for every column pointer colpt, and returns to the process of step S200.

In step S204, the concatenation circuitry 120 determines whether or not to continue the loop process corresponding to the data number IendOt. In a case where the loop process corresponding to the data number IendOt is not completed, the concatenation circuitry 120 performs the process of step S206 to continue the loop process, and in a case where the loop process corresponding to the data number IendOt is completed, the concatenation circuitry 106 performs the process of step S208. In step S206, the concatenation circuitry 120 concatenates the input data in[i] with the data held in the register tempBuff[ ], while updating the column pointer colpt, and returns to the process of step S204.

In step S208, the concatenation circuitry 120 determines whether or not a sum of the column pointer colpt and the data number IendOt exceeds the column size PESize, and performs the process of step S210 in a case where the sum exceeds the column size PESize, and performs the process of step S212 in a case where the sum does not exceed the column size PESize. In step S210, the concatenation circuitry 120 sets the output flag outFlag to “1”, and performs the process of step S214 in FIG. 14. In step S212, the concatenation circuitry 120 sets the output flag outFlag to “0”, and performs the process of step S214 in FIG. 14.

In step S214 in FIG. 14, the concatenation circuitry 120 determines whether or not the output flag outFlag is “1”, and performs the process of step S216 in a case where the output flag outFlag is “1”, and performs the process of step S226 in a case where the output flag outFlag is “0”. In step S216, the concatenation circuitry 120 determines whether or not to continue the loop process corresponding to the column size PESize. The concatenation circuitry 120 performs the process of step S218 in a case where the loop process corresponding to the column size PESize is not completed, and performs the process of step S220 in a case where the loop process corresponding to the column size PESize is completed. In step S218, the concatenation circuitry 120 transfers the data held in the data buffer dataBuff[ ] to the register tempBuff[ ] for every column pointer colpt, and returns to the process of step S216.

In step S220, the concatenation circuitry 120 updates the column pointer colpt according to the size of the data to be written into SPM 300, and writes the data corresponding to the column size PESize into SPM 300. Next, in step S222, the concatenation circuitry 120 determines whether or not to continue the loop process corresponding to the column size PESize. The concatenation circuitry 120 performs the process of step S224 in a case where the loop process corresponding to the column size PESize is not completed, and ends the operation illustrated in FIG. 13 and FIG. 14 when the loop process corresponding to the column size PESize is completed. In step S224, the concatenation circuitry 120 stores the remaining data, excluding the data written into the SPM 300, among the data held in the register tempBuff[ ], into the data buffer dataBuff[ ], and returns to the process of step S222.

In a case where the data is not written into the SPM 300, the concatenation circuitry 120, in step S226, determines whether or not to continue the loop process corresponding to the data number IendOt. The concatenation circuitry 120 performs the process of step S228 in a case where the loop process corresponding to the data number IendOt is not completed, and performs the process of step S230 in a case where the loop process corresponding to the data number IendOt is completed. In step S228, the concatenation circuitry 120 transfers the data corresponding to the data number IendOt, input from the compaction circuitry 110 and held in the register tempBuff[ ], to the data buffer dataBuff[ ]. In step S230, the concatenation circuitry 120 updates the column pointer colpt by adding the data number IendOt to the current column pointer colpt, and ends the operations illustrated in FIG. 13 and FIG. 14.

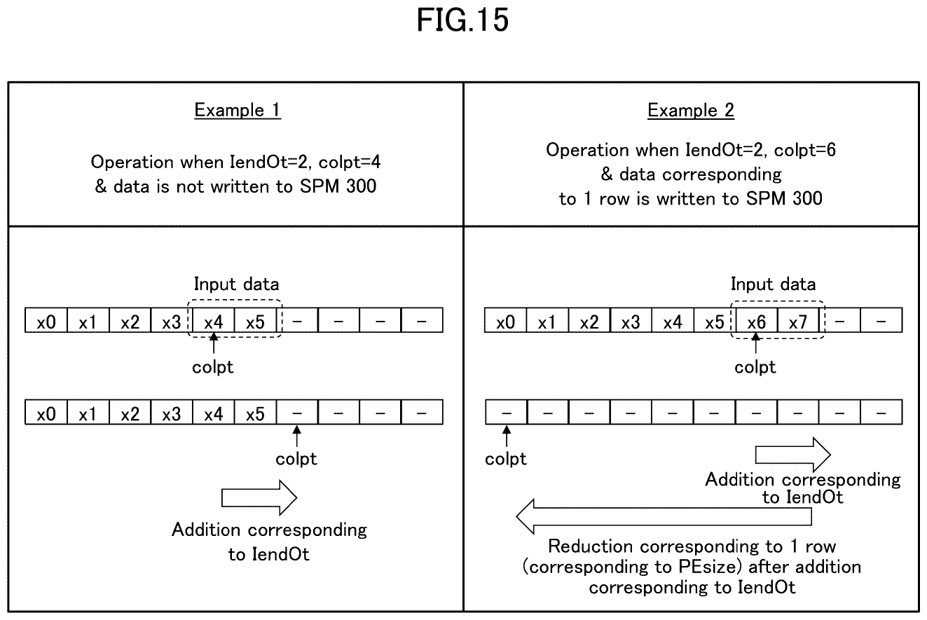

FIG. 15 illustrates an outline of the operation of the output generator 123 in FIG. 10. An example 1 illustrates the operation when the data number IendOt is “2”, the column pointer colpt is “4”, and the output data is not written from the output generator 123 into the SPM 300. For example, the input data x4 and x5 are supplied from the compaction circuitry 110. In this case, even if the column pointer colpt is incremented by the data number IendOt, the column pointer colpt does not reach the column size PESize. For this reason, the output generator 123 does not write data into the SPM 300.

An example 2 illustrates the operation when the data number IendOt is “2”, the column pointer colpt is “6”, and the data is written from the output generator 123 into the SPM 300. The compaction circuitry 110 supplies the input data x6 and x7. In this case, when the column pointer colpt is incremented by the data number IendOt, the column pointer colpt reaches the column size PESize. For this reason, the output generator 123 writes the data x0 through x7 corresponding to one row into SPM 300, and decrements the column pointer colpt by one row (that us, by the column size PESize). Thus, the column pointer colpt is initialized to “0”.

As described above, in the embodiment illustrated in FIG. 1 through FIG. 15, the compaction circuitry 110 can autonomously perform the operation of left-aligning each data of the data group received from the computational array 190 and outputting the left-aligned data to the concatenation circuitry 120, without being controlled by an external controller or the like. In this case, the compaction circuitry 110 can autonomously generate the selection signal sel for operating the selectors SELa and SELb of the data holding element D, based on the compaction information CompactionSize and the offset information Offset included in the operation specifications of the computational array 190.

The concatenation circuitry 120 can autonomously perform an operation of concatenating the left-aligned data of the data group sequentially received from the compaction circuitry 110, and writing the data corresponding to the write size into the SPM 300 every time the concatenated data reaches the write size (PESize) of the SPM 300.

By providing only the data holding elements D required to modify the data array in the data holding array 111, it is possible to reduce the circuit scale of the data holding array 111, and reduce the circuit scale of the compaction circuitry 110.

The data holding element Dc can select the data output from the data holding element D in the upper row having the same column number or the data output from the data holding element D in the upper row having a column number that is one larger. For this reason, after the data received from the computational array 190 reaches the column to be output to the concatenation circuitry 120, the compaction circuitry 110 sequentially transfers the data to the data holding elements D in the same column, to enable the data of the data group to be left-aligned autonomously.

By providing the selector SELc in the data holding element Dc, the data received from the data holding element D in the upper row can be passed through. Accordingly, it is possible to output a plurality of data included in the data group received from the computational array 190 to the concatenation circuitry 120 with the delay amounts of the plurality of data made uniform, and concatenate the plurality of data with other data.

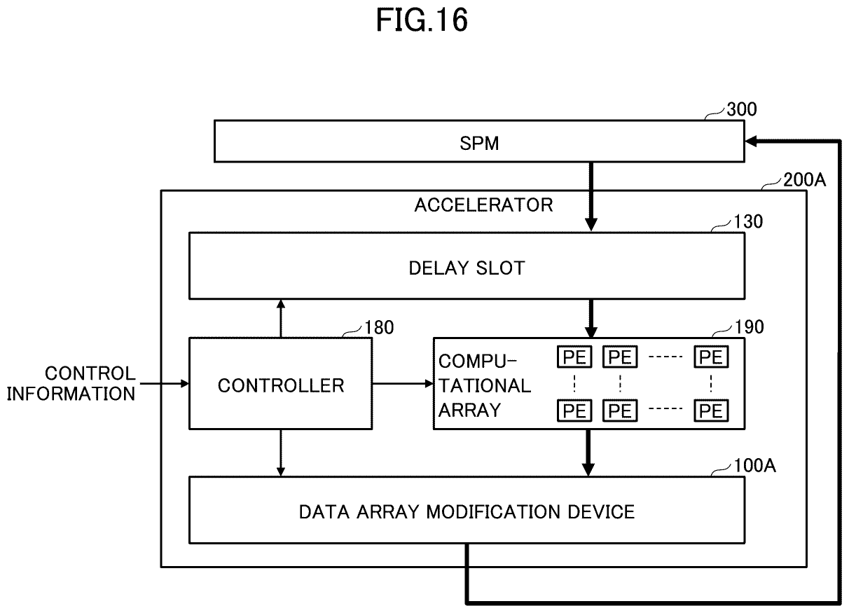

FIG. 16 illustrates an example of the data array modification device according to another embodiment. In FIG. 16, constituent elements that are the same as those illustrated in FIG. 1 are designated by the same reference numerals, and a detailed description thereof will be omitted. A data array modification device 100A illustrated in FIG. 16 has the same functions as the functions of the data array modification device 100 illustrated in FIG. 1, except that the data array modification device 100A has a function of operating as a systolic array.

An accelerator 200A equipped with the data array modification device 100A has a delay slot 130 between the SPM 300 and the computational array 190. The configuration and functions of the accelerator 200A are the same as those of the accelerator 200 illustrated in FIG. 1, except that the controller 180 includes a function of controlling the delay slot 130.

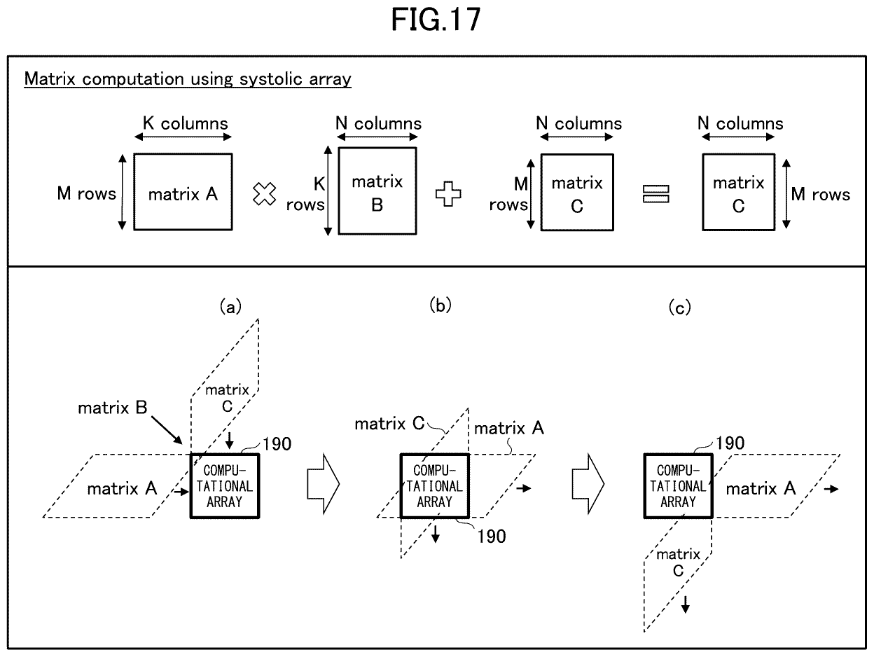

FIG. 17 illustrates an example of performing a matrix multiplication by operating the computational array 190 of FIG. 16 as a systolic array. For example, in the matrix multiplication performed by the systolic array, a process of adding a matrix C to a matrix product of a matrix A and a matrix B to obtain a new matrix C is repeated.

In a case where the computational array 190 is operated as a systolic array, data of the matrix A are input to the computational array 190 from the right end by shifting the data by one cycle from the upper row to the lower row. Data of the matrix C are input to the computational array 190 from the left end by shifting the data by one cycle from the upper row to the lower row. The matrix B is latched in the flip-flop circuit of each PE of the computational array 190 before inputting the matrix A and the matrix C to the computational array 190.

Each PE of the PEs (not illustrated) arranged in a matrix in the computational array 190 performs the matrix multiplication for every one cycle, and supplies the matrix C, which is the multiplication result, to the next PE. Further, the matrix multiplication is sequentially performed by the PEs from the upper left PE to the lower right PE of the computational array 190 in FIG. 17. The matrix multiplication is performed in an overlapping portion of a dashed parallelogram representing the matrix A and a dashed parallelogram representing the matrix C.

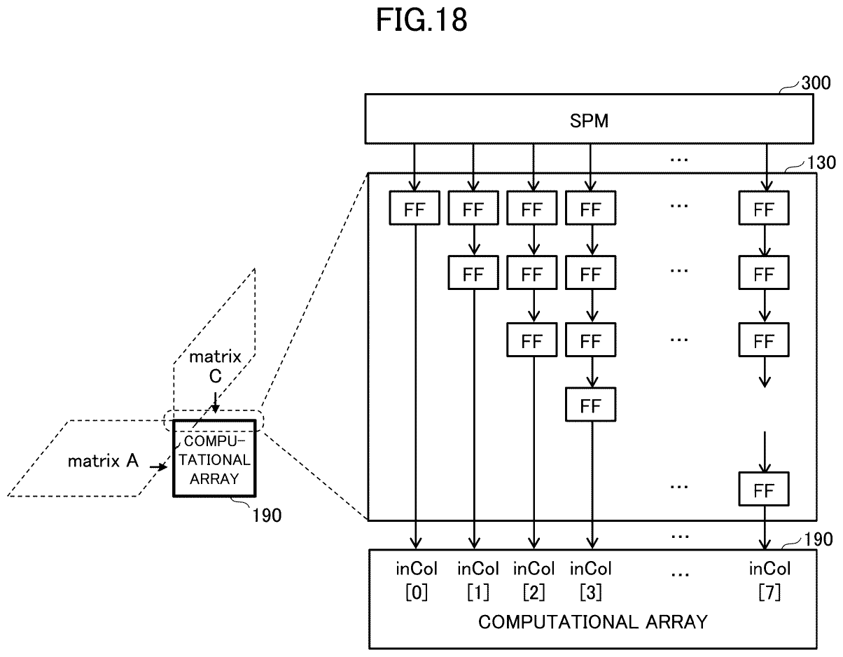

FIG. 18 illustrates an example in which the input of the matrix C to the computational array 190 illustrated in (a) of FIG. 17 is achieved by the delay slot 130. The delay slot 130 is configured by decreasing the number of flip-flop circuits FF located on the left side by one from the upper row to the lower row.

Thus, the data of each column output in parallel from the SPM 300 can be supplied to input terminals inCol of the computational array 190 with a delay of one cycle from the left to right. That is, the data of each column sequentially output in parallel from the SPM 300 and arranged in a rectangular shape can be converted into the data arranged in a parallelogram shape and supplied to the computational array 190. The delay slot (not illustrated) corresponding to the matrix A has the same configuration as the delay slot 130, and converts the data of each row sequentially output in parallel from the SPM 300 and arranged in a rectangular shape into the data arranged in a parallelogram shape and supplies the data with the converted arrangement to the computational array 190.

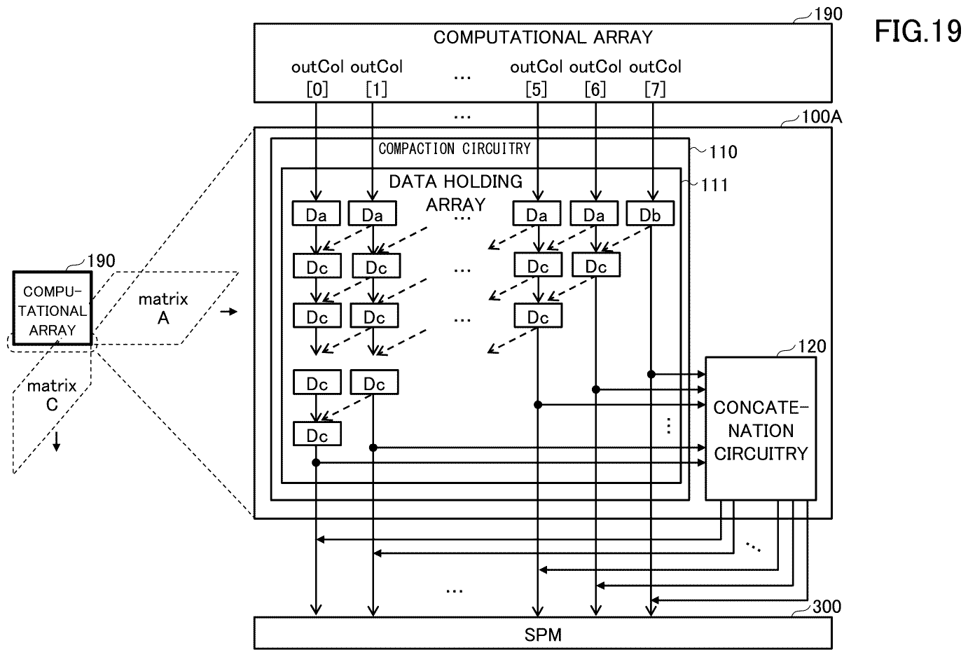

FIG. 19 illustrates an example in which the output of the matrix C from the computational array 190 illustrated in (c) of FIG. 17 is achieved by the data array modification device 100A. The data array modification device 100A illustrated in FIG. 19 illustrates the data holding array 111 (FIG. 6) and the concatenation circuitry 120 of the data array modification device 100 illustrated in FIG. 2. The configuration and functions of the data array modification device 100A are the same as those of the data array modification device 100 described above with reference to FIG. 1 through FIG. 15.

The data holding array 111 including the plurality of data holding elements D is configured by decreasing the number of data holding elements D located on the right side by one from the upper row to the lower row. As a result, the computational array 190 operating as a systolic array that outputs the data of the computation results earlier in the left columns can output the data to the SPM 300 as parallel data.

That is, the data of each column output from the computational array 190 and arranged in a parallelogram shape can be converted into the data arranged in a rectangular shape and output to the SPM 300. A data array modification device (not illustrated) corresponding to the matrix A has the same configuration as the data array modification device 100, and can convert the data of each row output from the computational array 190 and arranged in a parallelogram shape into the data arranged in a rectangular shape and output the data arranged in the rectangular shape to the SPM 300.

As described above, the embodiment illustrated in FIG. 16 through FIG. 19 can also obtain the same effects as those obtainable by the embodiment illustrated in FIG. 1 through FIG. 15. For example, the compaction circuitry 110 can autonomously perform an operation of left-aligning each data of the data group received from the computational array 190 and outputting the left-aligned data to the concatenation circuitry 120, without being controlled by an external controller or the like. The concatenation circuitry 120 can autonomously perform an operation of concatenating the left-aligned data of the data group sequentially received from the compaction circuitry 110 and writing the concatenated data corresponding to the write size into the SPM 300 every time the concatenated data reaches the write size of the SPM 300.

Further, in the embodiment illustrated in FIG. 16 through FIG. 19, the data of each column sequentially output in parallel from the SPM 300 and arranged in a rectangular shape can be converted into the data arranged in a parallelogram shape and supplied to the computational array 190. Hence, it is possible to operate the computational array 190 as a systolic array. In addition, the data output from the computational array 190 operating as a systolic array can be output to the SPM 300 as parallel data. That is, the data of each row output from the computational array 190 and arranged in a parallelogram shape can be converted into the data arranged in a rectangular shape and output to the SPM 300.

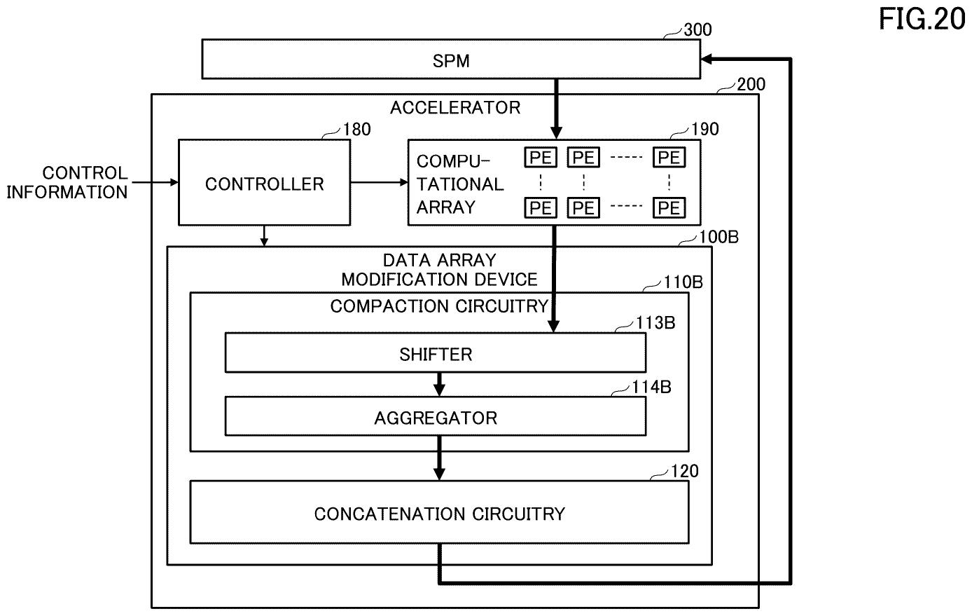

FIG. 20 illustrates an example of the data array modification device according to another embodiment. In FIG. 20, constituent elements that are the same as those illustrated in FIG. 1 are designated by the same reference numerals, and a detailed description thereof will be omitted. A data array modification device 100B illustrated in FIG. 20 includes a compaction circuitry 110B in place of the compaction circuitry 110 illustrated in FIG. 1. The compaction circuitry 110B includes a shifter 113B that receives the data from the computational array 190, and an aggregator 114B that is connected to an output of the shifter 113B. An output of the aggregator 114B is connected to the concatenation circuitry 120.

The configuration of the data array modification device 100B, except for the compaction circuitry 110B, is the same as the configuration of the data array modification device 100 illustrated in FIG. 1. The configuration and functions of the accelerator 200 including the data array modification device 100B are the same as those of the accelerator 200 in FIG. 1. The accelerator 200 is connected to the SPM 300.

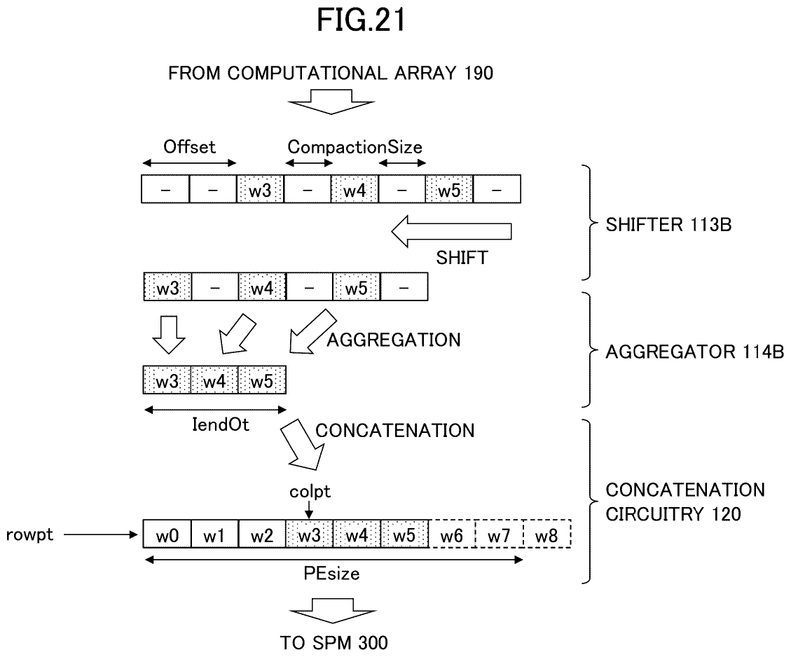

FIG. 21 illustrates an outline of the operation of the data array modification device 100B illustrated in FIG. 20. In the example illustrated in FIG. 21, it is assumed that the compaction information CompactionSize is “1”, the offset information Offset is “2”, and the data number IendOt of the data group output in a single output from the computational array 190 is “3”.

The shifter 113B eliminates an offset by shifting the data x3, x4, and x5, which are computation results of the computational array 190, to the left. The aggregator 114B shortens the intervals between the data x3, x4, and x5 eliminated of the offset and received from the shifter 113B. The data x3, x4, and x5 having the shortened intervals are concatenated with other data by the concatenation circuitry 120, and written into the SPM 300 for every data of the column size PESize. The operation of the concatenation circuitry 120 is the same as that in FIG. 4.

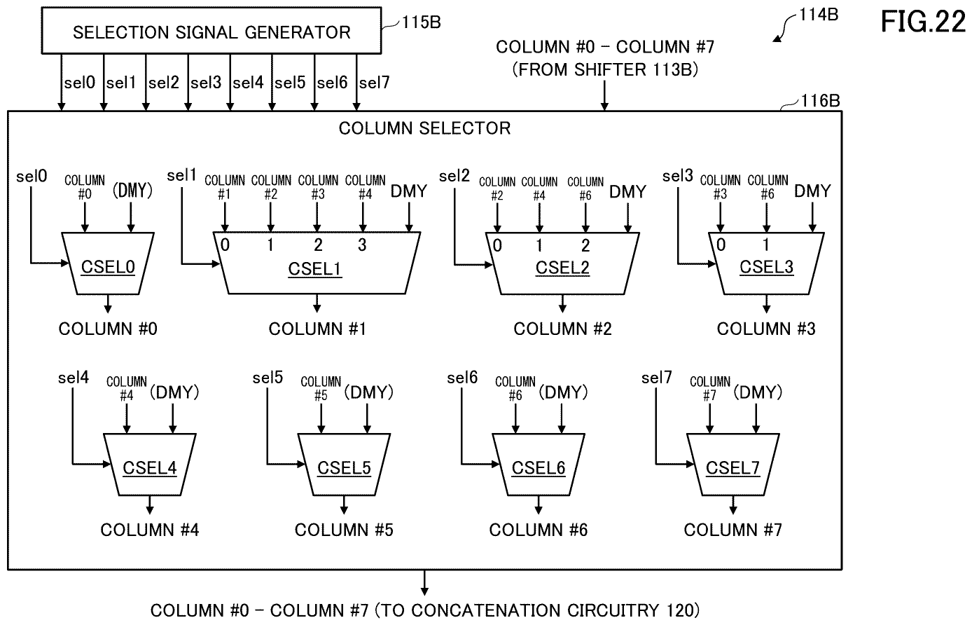

FIG. 22 illustrates an example of a configuration of the aggregator 114B in FIG. 20. In the example illustrated in FIG. 22, the aggregator 114B includes a selection signal generator 115B and a column selector 116B. The column selector 116B includes column selection elements CSEL (CSEL0 through CSEL7) for every eight columns. The column selector 116B modifies the data array of columns #0 through #7 received from the shifter 113B in FIG. 20, and outputs the modified data array of the columns #0 through #7 to the concatenation circuitry 120 in FIG. 20. For example, in the example illustrated in FIG. 21, the aggregator 114B outputs the data x3, x4, and x5 received from the columns #0, #2, and #4 with the intervals as left-aligned data x3, x4, and x5 from the columns #0, #1, and #2.

Each column selection element CSEL outputs one of the input data and or dummy data DMY to the concatenation circuitry 120 according to the selection signal sel (sel0 through sel7) generated by the selection signal generator 115B. A numerical value added to the input of each column selection element CSEL indicates the compaction information CompactionSize. Each column selection element CSEL receives the data received by the column indicated by a multiple of the number assigned to the column selection element CSEL and the dummy data DMY.

For example, the column selection element CSEL1 receives the data of the columns #1, #2, #3, and #4 corresponding to the multiples of “1” and the dummy data DMY. The column selection element CSEL2 receives the data of the columns #2, #4, and #6 corresponding to the multiples of “2” and the dummy data DMY. The column selection element CSEL3 receives the data of the columns #3 and #6 corresponding to the multiples of “3” and the dummy data DMY.

The column selection element CSEL0 receives the data of the column #0 and the dummy data DMY, but does not select the dummy data DMY. The column selection element CSEL4 receives the data of the column #4 and the dummy data DMY. The column selection element CSEL5 receives the data of the column #5 and the dummy data DMY. The column selection element CSEL6 receives the data of the column #6 and the dummy data DMY. The column selection element CSEL7 receives the data of the column #7 and the dummy data DMY. Accordingly, the column selection elements CSEL4 through CSEL7 receive the data received by columns indicated by multiples of the numbers assigned to the column selection elements CSEL and the dummy data DMY, similar to the column selection elements CSEL1 through CSEL3.

In this embodiment, the compaction circuitry 110B does not have a plurality of data holding elements D as in the compaction circuitry 110 illustrated in FIG. 6, and thus, the circuit scale can be reduced compared to the compaction circuitry 110. As a result, it is possible to reduce the circuit scale of the accelerator 200.

The compaction circuitry 110 (FIG. 4 and FIG. 6) of the embodiments described above uses the plurality of data holding elements D to perform, in parallel, the process of shortening the intervals of the data indicated by the compaction information CompactionSize, and the process of left-aligning the data by an amount corresponding to the offset information Offset. In contrast, in this embodiment, the process of left-aligning the data by the amount corresponding to the offset information Offset is independently performed by the shifter 113B, and the process of shortening the intervals of the data indicated by the compaction information CompactionSize is independently performed by the aggregator 114B. The shifter 113B can be implemented by a simple shift register.

Some users of the accelerator 200 may request to use only one of the process of shifting the column to which the data is output or the process of shortening the intervals of the data. In addition, some users may request to change or extend only the parameters used for the process of shortening the intervals of the data. In this embodiment, such user's request can be satisfied by modifying the design or the functions of only one of the shifter 113B or the aggregator 114B, and improve the functional expandability. In addition, it is possible to prevent verification of the design modification or the function modification from becoming complex, and to reduce the man-hours required for the verification tasks, for example.

As described above, the embodiment illustrated in FIG. 20 through FIG. 22 can also obtain the same effects as those obtainable by the embodiment illustrated in FIG. 1 through FIG. 15. For example, the compaction circuitry 110B can independently perform the operation of left-aligning each data of the data group received from the computational array 190 and outputting the left-aligned data to the concatenation circuitry 120, without being controlled by an external controller or the like. The concatenation circuitry 120 can autonomously perform the operation of concatenating the left-aligned data of the data group sequentially received from the compaction circuitry 110B and writing the data having the write size into the SPM 300 every time the concatenated data reaches the write size of the SPM 300.

Furthermore, in the embodiment illustrated in FIG. 20 through FIG. 22, the circuit scale of the compaction circuitry 110B can be made smaller than the circuit scale of the compaction circuitry 110 illustrated in FIG. 6, and it is possible to reduce the circuit scale of the accelerator 200. Accordingly, it is possible to modify the design or the functions of only one of the shifter 113B or the aggregator 114B in response to a user's request, and improve the functional expandability, for example. In addition, it is possible to prevent the verification of the design modification or the function modification from becoming complex, and to reduce the man-hours required for the verification tasks.

According to the embodiments of the present disclosure, it is possible to reduce a load on a controller that controls a computational array while suppressing deterioration in a performance of the computational array, by disposing a data array modification device that modifies an array of data to be supplied to the computational array outside the computational array and autonomously operating the data array modification device.

Various aspects of the subject-matter described herein may be set out non-exhaustively in the following numbered clauses:

1. A non-transitory computer-readable storage medium having stored therein a data array modification program for modifying an array of data output from an computational array including a plurality of computational elements arranged in a matrix to an array to be written to a memory, the data array modification program, when executed by a computer, causing the computer to perform a process comprising:
eliminating intervals between predetermined first data included in a data group output from the computational array and shifting the predetermined first data to one end to generate second data; and
concatenating the second data output from the compaction circuitry to other data and modifying the concatenated data into the array to be written to the memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data array modification device that modifies an array of data output from a computational array including a plurality of computational elements arranged in a matrix into an array to be written to a memory, the data array modification device comprising:
compaction circuitry configured to eliminate intervals between predetermined first data included in a data group output from the computational array, and shift the predetermined first data to one end to generate second data; and
concatenation circuitry configured to concatenate the second data output from the compaction circuitry to other data and modify the concatenated data into the array to be written to the memory.

2. The data array modification device as claimed in claim 1, wherein the compaction circuitry eliminates the intervals between the predetermined first data included in the data group based on compaction information included in operation specifications of the computational array, and shifts the predetermined first data to the one end based on offset information included in the operation specifications.

3. The data array modification device as claimed in claim 1, wherein:
the compaction circuitry includes a data holding array of m rows by m columns, where m is an integer greater than or equal to two,
the data holding array has a first row including m data holding elements, and second through m-th rows including {m−(row number)+1} data holding elements aligned to a left end at a first column of the data holding array, respectively,
the data holding elements in the first row on the computational array side excluding a last column constitute first data holding elements configured to hold the data output from the computational array, respectively,
the data holding elements in the last column of the first row on the computational array side constitute second data holding elements including a first selector configured to select one of the data output from the computational array or dummy data DMY and hold the data selected by the first selector, respectively,
the data holding elements in the second through m-th rows on the computational array side constitute third data holding elements including a second selector configured to select one of data output from the data holding element in the same column of a previous row, data output from the data holding element in a column having a column number one greater of the previous row, or the dummy data, and hold the data selected by the second selector, respectively, and
an output of the data holding element in the last column of each row is coupled to an input of the concatenation circuitry.

4. The data array modification device as claimed in claim 3, wherein the compaction circuitry includes a selection signal generator configured to generate selection signals for causing the first selector and the second selector to select the data based on an output column of data determined by operation specifications of the computational array.

5. The data array modification device as claimed in claim 4, wherein the selection signal generator is configured to:
generate the selection signal for causing the third data holding element to select the data output from the data holding element in a row having a column number one greater until the data received from the computational array reaches a column to which the data is to be output from the concatenation circuitry,
generate the selection signal for causing the data holding element to select the data output from the data holding element in the same column after the data received from the computational array reaches the column to which the data is to be output from the concatenation circuitry, and
further generate the selection signal for causing a third data holding element that does not output data among the third data holding elements in the last row to select the dummy data.

6. The data array modification device as claimed in claim 3, wherein each data holding element among the data holding elements in the second through m-th rows on the computational array side includes:
a holding circuit configured to hold the data output from the second selector, and
a third selector configured to select and output one of the data output from the second selector or the data held in the holding circuit.

7. The data array modification device as claimed in claim 1, wherein the concatenation circuitry includes:
a data buffer configured to hold data;
a combiner configured to combine the data held in the data buffer and the second data output from the compaction circuitry, and
an output generator configured to retrieve data having a write size from the data buffer and write the retrieved data to the memory in a case where a size of the data combined by the combiner reaches the write size.

8. The data array modification device as claimed in claim 1, wherein:
the compaction circuitry includes a data holding array of m rows by m columns, where m is an integer greater than or equal to two,
the data holding array has each row including {m−(row number)+1} data holding elements aligned to a left end at a first column of the data holding array,
the data holding elements in a first row on the computational array side excluding a last column constitute first data holding elements configured to hold the data output from the computational array,
the data holding elements in the last column in the first row on the computational array side constitute second data holding elements including a first selector configured to select one of the data output from the computational array or dummy data DMY and hold the data selected by the first selector,
the data holding elements in the second through m-th rows on the computational array side constitute third data holding elements including a second selector configured to select one of data output from the data holding element in the same column of a previous row, data output from the data holding element in a column having a column number one greater of the previous row, or the dummy data, and hold the data selected by the second selector,
outputs of the data holding elements in the last column of each row are coupled to an input of the concatenation circuitry,
the data holding elements in the first row receive a plurality of data sequentially output from the computational array operating as a systolic array with cycles shifted for each column,
the data holding elements in the first row excluding the last column sequentially transfer the received data to the data holding elements in the same column, and
the data holding elements in the first row of the last column output the received data to the memory.

9. The data array modification device as claimed in claim 1, wherein the compaction circuitry includes:
a shifter configured to shift the first data included in the data group output from the computational array to the one end, and
an aggregator configured to eliminate the intervals between the first data shifted by the shifter to generate the second data.

10. An information processing apparatus comprising:
a memory;
a computational array including a plurality of computational elements arranged in a matrix;
a controller configured to control an operation of the computational array; and
a data array modification device configured to modify an array of data output from the computational array to an array to be written to the memory, wherein the data array modification device includes:
compaction circuitry configured to eliminate intervals between predetermined first data included in a data group output from the computational array, and shift the predetermined first data to one end to generate second data; and
concatenation circuitry configured to concatenate the second data output from the compaction circuitry to other data and modify the concatenated data into the array to be written to the memory.

11. A data array modification method for modifying an array of data output from an computational array including a plurality of computational elements arranged in a matrix to an array to be written to a memory, the data array modification method comprising:
eliminating intervals between predetermined first data included in a data group output from the computational array and shifting the predetermined first data to one end to generate second data; and
concatenating the second data output from the compaction circuitry to other data and modifying the concatenated data into the array to be written to the mem
